(19) United States
(12) Patent Application Publication
(10) Pub. No.: US 2017/0298685 A1
(43) Pub. Date: Oct. 19, 2017

(54) PROTECTIVE LINING FOR A DOOR OR A WINDOW

(71) Applicant: Herbert Fred Witt, Fayetteville, NC (US)

(72) Inventor: Herbert Fred Witt, Fayetteville, NC (US)

(21) Appl. No.: 15/097,992

(22) Filed: Apr. 13, 2016

(51) Int. Cl. E06B 9/15; E06B 9/58; E06B 9/78; E06B 9/17; E06B 9/80

(52) U.S. Cl. CPC E06B 9/15; E06B 9/17061; E06B 9/581; E06B 9/78; E06B 9/17007; E06B 2009/1577; E06B 2009/785; E06B 2009/801; E06B 2009/1505

(57) ABSTRACT

A lining is provided that covers doors or windows to provide protection against all inclement weather conditions. The lining prevents sunlight or any other type light from entering inside a room. The lining that includes horizontal slotted blinds that are operated manually using a flat cord. The horizontal slotted blinds work using tongue and groove concept.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to the field of window blinds. The invention, particularly relates to a lining surrounding doors and windows that prevents sunlight from coming in and providing all weather protection.

### 2. Description of Related Art Including Information Disclosed Under 37 CFR 1.97 and 37 CFR 1.98.

Translucence is an optical property which is highly desirable in window coverings to afford admission of sunlight into a room during the day without compromising privacy at night and protect inside premise against an inclement weather such as windy conditions or storm or like. Adjustable window blinds are used to serve all the above mentioned purposes. The adjustable window blinds including venetian blinds, have been known in the art for many years, with a number of improvements in recent years. Most of the blinds in prior art provide varying degrees of protection against light filtration and line of sight vision.

Some of existing adjustable window blinds include prior art U.S. patent application Ser. No. 10/876,559 to Timothy Taylor, which discloses venetian blind system having an improved method for prohibiting light infiltration and line of sight vision through the closed blind and an improved method for preventing the blowing or flapping of the blind.

Another prior art U.S. patent application Ser. No. 10/883,230 to Sassan Khajavi discloses a vertical or horizontal window or skylight blind or shutter having slats which have two physically different surfaces on each face. The blinds overlap slightly at their long edges when closed, yet they are able to rotate at least 180 degrees around their longitudinal axis. One face of the slat has triangular grooves on it running parallel to the length of the slat. The triangular grooves are coated with a pigment that reflects by specular and/or direct diffusion the sun's electromagnetic energy, whereby the room is kept cool in summer and warm in winter.

Another prior art U.S. Pat. No. 6,015,002 issued to Biro et al discloses first version of a multilayer slat for horizontal or vertical blind assemblies includes a translucent inside layer, a first transparent base layer, and a translucent outside layer. This slat may also include a second base layer, which is either transparent or translucent depending on the percentage of light to be transmitted through the slat. The base layer may be of a different color than the inside layer, so that light transmitted through the slat is viewed as being differently colored than light reflected from the surface of the slat. The inside layer of the slat may include a foaming agent producing a matte surface texture. Another version of the multilayer slat includes a laminated inside layer, with a foaming agent in a base layer causing a matte surface texture of the laminated layer.

None of the above inventions and patents, taken either singly or in combination, is seen to describe the instant invention as claimed.

### BRIEF SUMMARY OF THE INVENTION

In the view of the foregoing disadvantages inherent in the known types of window blinds now present in the prior art, the present invention provides an improved window or door lining. As such, the general purpose of the present invention, which will be described subsequently in greater detail, is to provide a new and improved lining for doors or windows which has all the advantages of the prior art and none of the disadvantages.

An object of the invention is to provide a lining that covers doors or windows to provide protection against all inclement weather conditions.

It is another object of the present invention to provide a lining that also prevents sunlight or any other type light from entering inside a room.

It is another object of the present invention to provide a lining that includes horizontal slotted blinds that are operated manually using a flat cord.

It is another object of the present invention to provide the horizontal slotted blinds that work using tongue and groove concept.

It is another object of the present invention to provide a protection to the doors and windows against extreme weather conditions instead of reaching outside to pull heavy shutters.

It is yet another object of the present invention to provide the security to home or business when vacant.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 shows a perspective view of the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

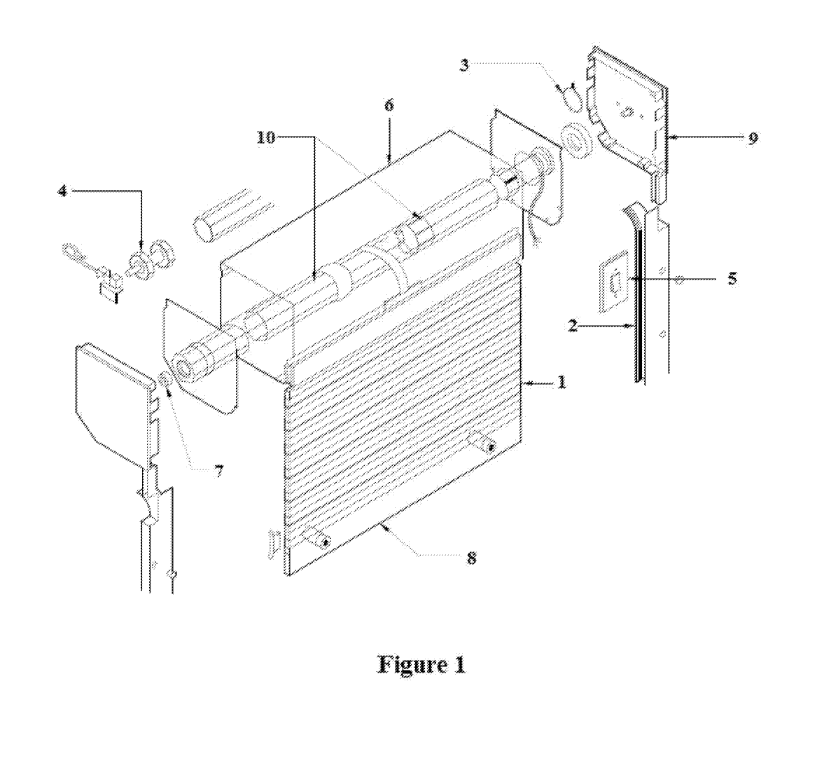

On referring FIG. 1 shows a preferred embodiment of the present invention for windows and doors. The figure shows a casing for horizontal slotted blinds (1). The casing or sliding track is three sided. The casing is shown to be installed on exterior of double windows. The slotted blinds measure, for example 3-3½ inch in width, and, ¼ inch in thickness. The blinds can have for example 1¼ inch to 1½ inch in height. The length of the blinds depends upon the door or window outside which they are installed. The shape of blinds is almost flat with a little arch in it. The window edge is at angle of 30 5′ from one side of casing. The tung and groove concept is in place for the sliding motion of the horizontal blinds. The blinds move up and down manually by use of a flat pull cord or rope. Similar type of installation is followed in installing the horizontal slotted blinds (1) on the exterior of doors. The blind may be made up of titanium, plastic, wood, PVC or sheet metal. The lighter the material used for making the blinds, the better it is for handling and installing.

According to the preferred embodiment of the present invention works by manually pulling of a flat pull cord that runs vertical on one side of the window inside of the premise. The cord operates on a pulley system that is above the window in a casing outside of the premise. Holding the flat cord with the hand and lowering the slotted blinds which are corrugated at the bottom of blind to control lighting lets a user to close for total darkness. The tong and grove theory is used for the slotted blinds to be secure. The blind works the same way to open to the amount of light needed or pull up blinds fully to open the window. The slotted blinds work off a round cylinder above the window outside which is located in a casing of plastic, aluminum or metal, depends on location based on weather conditions. The slotted blinds operate up and down very clean and efficiently. The flat pull cord can be stronger inter twined cord about 1″ to ½ wide, with white in color. This will sit very nice behind any curtain. This concept can also be controlled electronically with a remote control.

The slats can be operated manually using a flat pull cord to reduce purchase price and they offer good energy saving properties, privacy, shading, noise, lighting control, and comfort. These slats are filled with high-density foam that enhances durability and strength. Hard foam slats are the ideal solution for residential security and storm protection. The heavy-duty option of slats is for security and storm protection. Extra thick double walled aluminum will keep out the toughest of storms and potential criminals. Single wall systems have several punch options to control visibility and security.

A single wall slat is chosen for a lighter weight curtain that still performs like an all-aluminum slat. Visibility can be increased with the grid and rectangle punch options. PVC slats are also lightweight and easy to clean. PVC rolling shutters can match the PVC construction of existing window and door openings. They provide energy efficiency and moderate resistance to storms and debris. Lexan is a lightweight transparent system which increases visibility and establishes a physical barrier. Side locks keep the individual slats in the curtain aligned. End retention side locks must be chosen for enhanced security. They increase a shutter's stability against pullout at high stress loads. Base slats seal the curtain at the bottom area. Plastic stops prevent the shutter curtain from rolling past the box cover (6) on manually operated shutters. Locks & security devices provide enhanced security on shutter and are also recommended.

Mini & maxi side rails are the vertical structures that attach the slat curtain to the wall and guide the curtain during vertical movement. The type of rail you choose will be decided on whether the curtain contains a smaller mini slat or a larger maxi slat. See the slat references next to each part for more information on which is right for a given shutter. End retention side rails (2) are chosen when high security or severe weather protection is necessary. These rails have an additional aluminum extrusion that locks slats into the rail, preventing pullout under high pressure.

Note that a special end retention side lock and slat are required. Aluminum angles provide a resting point for shutters when an opening lacks a still or stopping point. Storm bars provide an additional level of resistance to shutter deflection in severe wind areas. They act as a physical brace that is positioned in the center of two rails to mediate pressure. Storm bars are removable during less inclement weather. Build out extra material used when a shutter must clear any obstruction such as a window frame. Select build out materials in conjunction with the size of rail used and the clearance away from the wall required. The box covers protect the internal working parts of a shutter and act as a housing for a rolled up shutter curtain and are highly recommended for external applications. In addition, the box cover is configured to have a pair of box cap (9) on both sides of it.

Side caps connect the rails to the axle of the shutter. Choose side caps that are appropriate for the curtain rail and box cover (6) (45 or 90 degrees). Safety plates create a barrier between the shutter curtain and the side cap. These plates prevent the curtain from sliding off the center of the track which would cause damage to slats. Split unit shutters are multiple shutters that run on one operator which can lower production costs of a project and further, the box cover is used to protect a roller system (10) inside it.

Tube or axles are the structural center of the rolling shutter. Curtains attach and roll around the tube. Choose a tube based on the operator type, curtain weight and curtain size. Spring lock (3) hangers are used to secure the slats into a locking vertical position and attach the slat curtain with the axle. Slat type will determine the spring lock hanger used (mini/maxi slat). The Caps (4) are located on the inside of the axle on the opposite side of the operator. They assist in turning the axle. Type of idler is determined by the weight of shutter and size of axle. Adapters are rings on the outside of the axle that transition different axle diameters. This is accomplished by converting an octagonal receptor to a circular one. Adapter also aids in maintaining uniform curtain roll up. Mounting plates or brackets are mounted to side caps and support the axle and operator. They also connect the axle or operator to the side cap. Bearings (7) are located inside the cap or idler and help turn the curtain. Bearing is determined by the type of cap used.

Gears are attached to the side cap and are used for manual operation. Gear accessories attach the gear to the axle and aide in turning the axle. Universal shaft is a rod that attaches the gear to a crank handle and allows manual operation of a shutter. The hole in the gear (hex or square) and type of end joint (with or without bullet) determines the type of universal needed. Cranks are the end point of operation and allow the user to physically operate a gear driven shutter. Cranks vary in length and end types as well as permanent or removable mounting. Assist springs help lift the weight of a manually operated shutter with a gear. These springs can be used on heavy curtains for more convenient operation.

In another embodiment of the current invention, electronic motors aid in lifting shutters for convenience of operation or for shutters that are too heavy to lift manually. Choose a motor type based on the shutter weight and size. Crowns or drives attach the motor to the axle and assist in turning the shutter. Crown or drive sizes are dependent on the size of the motor and axle.

Mounting brackets are provided for mounting the shutter to the building fascia. Switches (5) operate a motorized shutter. Choice of switch is determined by style. Transmitters remotely operate shutters. Transmitters are capable of operating a single shutter as well as multiple shutters. Control systems assign individual shutter motors to a transmitter. These can be assigned to work individually or have all of the shutters operated at once. Garage door parts are designed with a heavier duty construction than typical shutter parts to allow wider applications.

Using a rolling shutter (8) as a garage door reclaims unused space that was previously taken up by standard garage door rail. Standard storm panels are a cost effective alternative to rolling shutters for hurricane protection. They stack flat when not in use. Egress storm panels include an escape panel that is operated by removing a safety pin and opening up the storm panel. Mounting hardware that attaches the storm panel to the wall. This hardware is left on the building when the storm panels are not in use. End-locking bench is specially crafted table that aides in curtain assembly. Expandable table allows variance in curtain sizes, with additional rolling center support to prevent sagging in larger curtains. Saw is provided for accurate cutting of rolling shutter profiles and box covers designed for high precision and burr free cut. Feeding tables with electronic or manual read out available. Pneumatic tools are recommended and dependable tools for rolling shutter assembly.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. A protective lining for a door or a window, comprising:
a plurality of single wall slats;
a plurality of side locks;
at least one side rail;
a box cover;
an axle; and
a plurality of gears.

2. The protective lining for a door or a window according to claim 1, wherein said protective lining provides full covering of said door or said window for all weather conditions.

3. The protective lining for a door or a window according to claim 1, wherein plurality of single wall slat are provided for a light weight curtain.

4. The protective lining for a door or a window according to claim 1, wherein said plurality of single wall slat is operated manually by pulling a flat cord.

5. The protective lining for a door or a window according to claim 4, wherein said flat cord runs vertically on one side of said window or door inside a premise.

6. The protective lining for a door or a window according to claim 4, wherein said flat cord operates on a pulley system above window or door in a casing outside said premise.

7. The protective lining for a door or a window according to claim 1, wherein said plurality of single wall slat are individually filled with high density foam.

8. The protective lining for a door or a window according to claim 1, wherein said plurality of side locks are end retention side locks.

9. The protective lining for a door or a window according to claim 8, wherein said plurality of side locks keep said curtain aligned.

10. The protective lining for a door or a window according to claim 1, wherein at least one side rail attaches to said plurality of single wall slats to a wall.

11. The protective lining for a door or a window according to claim 1, wherein an additional extrusion provided in at least one side rail locks plurality of single wall slats.

12. The protective lining for a door or a window according to claim 1, wherein said plurality of removable storm bars is provided in center of two side rails.

13. The protective lining for a door or a window according to claim 12, wherein said plurality of removable storm bars provide an additional resistance to any deflection.

14. The protective lining for a door or a window according to claim 1, wherein said box cover protects internal working parts of a shutter.

15. The protective lining for a door or a window according to claim 14, wherein said box cover also acts as a rolled up shutter curtain.

16. The protective lining for a door or a window according to claim 1, wherein said plurality of side caps connect at least one side rail to said axle.

17. The protective lining for a door or a window according to claim 16, wherein size of said plurality of side caps is according to size of at least one side rail and size of said box cover.

18. The protective lining for a door or a window according to claim 16, wherein a barrier is created between a shutter curtain and said plurality of side caps by said plurality of safety plates.

19. The protective lining for a door or a window according to claim 1, said axle is structural center of said shutter curtain.

20. The protective lining for a door or a window according to claim 19, said shutter curtain is attached to and rolls around said axle.

21. The protective lining for a door or a window according to claim 19, wherein said plurality of plastic stops prevent said shutter curtain from rolling past said box cover when manually operated.

22. The protective lining for a door or a window according to claim 1, wherein said plurality of spring lock hangers secure plurality of single wall slats into a vertical position.

23. The protective lining for a door or a window according to claim 22, wherein said plurality of spring lock hangers attach said shutter curtain with said axle.

24. The protective lining for a door or a window according to claim 1, wherein said plurality of gears is attached to said plurality of side caps.

25. The protective lining for a door or a window according to claim 1, wherein said gear accessories attach each individual gear out of said plurality of gears to said axle

26. The protective lining for a door or a window according to claim 25, wherein a universal shaft attaches said plurality of gears to a crank handle.

27. The protective lining for a door or a window according to claim 26, wherein said universal shaft facilitates manual operation of said axle.
